(19) United States
(12) Patent Application Publication
(10) Pub. No.: US 2026/0154178 A1
(43) Pub. Date: Jun. 4, 2026

(54) SENSITIVE REGIONS AROUND REGISTER TRANSFER LEVEL (RTL) CODE OBJECTS ON VISUAL DISPLAY

(71) Applicant: Singularity Dynamics Private Limited, Bangalore (IN)

(72) Inventor: Harish Kumar, Bangalore (IN)

(21) Appl. No.: 19/404,033

(22) Filed: Dec. 1, 2025

Related U.S. Application Data
(60) Provisional application No. 63/726,344, filed on Nov. 29, 2024.

(51) Int. Cl. G06F 11/3604; G06F 11/362

(52) U.S. Cl. CPC G06F 11/3608; G06F 11/362

(57) ABSTRACT

Disclosed subject matter relates to verification and debugging tool and method for providing sensitive regions around and in Register Transfer Level (RTL) code objects. The verification and debugging tool includes input interface configured to receive RTL code in Hardware Description Language (HDL). Further, verification and debugging tool includes RTL parser configured to parse RTL code, and generate abstract syntax tree representing syntactic structure of RTL code. Thereafter, verification and debugging tool includes graph converter configured to convert abstract syntax tree into RTL directed graph. Furthermore, verification and debugging tool includes visual display configured to display code blocks, each exhibiting sensitive regions. Finally, verification and debugging tool includes objects extractor configured to detect user actions related to sensitive regions. The sensitive regions are provided around and in each of RTL code objects to facilitate extraction and display of relevant information regarding dependencies and operations of RTL code upon user interactions.

### CROSS-REFERENCE TO RELATED APPLICATIONS

The present application claims the benefit of priority to U.S. Provisional Application No. 63/726,344, filed on November 29, 2024; the contents of which are hereby incorporated by reference herein in their entirety.

### TECHNICAL FIELD

The present disclosure relates to electronic design. Particularly, the present disclosure relates to a technique of providing sensitive regions around and in the Register Transfer Level (RTL) code objects.

### BACKGROUND

Modern electronic design is typically performed with Computer-Aided Design (CAD) tools or Electronic Design Automation (EDA) systems. To design an Integrated Circuit (IC) device, a designer first creates high-level behavior descriptions of the IC device using a hardware description language (HDL) such as Verilog and VHDL. As the complexity of the IC devices is growing exponentially due to changes such as shrinking in size of the IC chips and integration of more functionality onto a single IC chip, the behavioral descriptions of the devices are also becoming complex due to a large number of code blocks written in HDL for the IC chips.

A verification engineer usually identifies and resolves the errors or bugs present in the written code blocks using verification and debugging tools. The existing verification and debugging tools represent different Register Transfer Level (RTL) code objects in a single color. In order to determine the values of the RTL code objects at a time stamp, the verification engineer either analyzes the waveform of the RTL code or the data flow between the code blocks manually at that particular time stamp. This makes the process of verification very complex, time-consuming and inefficient.

Therefore, a verification and debugging tool that has visual sensitive regions around blocks and objects for dependency expansion and other operations in an intuitive and easy manner will greatly improve the efficiency of debug.

The information disclosed in this background of the disclosure section is only for enhancement of understanding of the general background of the invention and should not be taken as an acknowledgement or any form of suggestion that this information forms the prior art already known to a person skilled in the art.

### SUMMARY

Disclosed herein is a verification and debugging tool for Register Transfer Level (RTL) code. The verification and debugging tool comprises an input interface configured to receive RTL code in a Hardware Description Language (HDL). Further, the verification and debugging tool comprises an RTL parser configured to parse the RTL code, and generate an abstract syntax tree representing the syntactic structure of the RTL code. Thereafter, the verification and debugging tool comprises a graph converter configured to convert the abstract syntax tree into an RTL directed graph. The RTL directed graph comprises plurality of code blocks. Each of the plurality of code blocks is represented as a node. Furthermore, the verification and debugging tool comprises a visual display configured to display the plurality of code blocks, each exhibiting sensitive regions. Finally, the verification and debugging tool comprises an objects extractor configured to detect one or more user actions related to the sensitive regions. The sensitive regions are provided around and in each of the one or more RTL code objects to facilitate the extraction and display of relevant information regarding dependencies and operations of the RTL code upon user interactions.

Further, disclosed herein is a method of providing sensitive regions around and in the Register Transfer Level (RTL) code objects. The method includes receiving RTL code in a Hardware Description Language (HDL). Further, the method includes parsing the RTL code, and generating an abstract syntax tree representing the syntactic structure of the RTL code. Thereafter, the method includes converting the abstract syntax tree into an RTL directed graph. The RTL directed graph comprises plurality of code blocks. Each of the plurality of code blocks is represented as a node. Furthermore, the method includes displaying the plurality of code blocks, each exhibiting sensitive regions. Finally, the method includes detecting one or more user actions related to the sensitive regions. The sensitive regions are provided around and in each of the one or more RTL code objects to facilitate the extraction and display of relevant information regarding dependencies and operations of the RTL code upon user interactions.

Furthermore, the present disclosure relates to a non-transitory computer readable medium including instructions stored thereon that when processed by at least one processor, cause a verification and debugging tool to perform operations comprising receiving RTL code in a Hardware Description Language (HDL). Further, the instructions cause the processor to parse the RTL code, and generate an abstract syntax tree representing the syntactic structure of the RTL code. Thereafter, the instructions cause the processor to convert the abstract syntax tree into an RTL directed graph. The RTL directed graph comprises plurality of code blocks. Each of the plurality of code blocks is represented as a node. Furthermore, the instructions cause the processor to display the plurality of code blocks, each exhibiting sensitive regions. Finally, the instructions cause the processor to detect one or more user actions related to the sensitive regions. The sensitive regions are provided around and in each of the one or more RTL code objects to facilitate the extraction and display of relevant information regarding dependencies and operations of the RTL code upon user interactions.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows an exemplary environment of providing sensitive regions around and in the Register Transfer Level (RTL) code objects, in accordance with some embodiments of the present disclosure;

FIG. 2 shows an exemplary illustration of sensitive regions on directed graph, in accordance with an embodiment of the present disclosure;

FIG. 3A shows a flowchart illustrating method of providing sensitive regions around and in the Register Transfer Level (RTL) code objects, in accordance with some embodiments of the present disclosure;

FIG. 3B illustrates a flow diagram of displaying relevant information when a sensitive region is clicked or pointed or hovered, in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or identity server proceeded by “comprises… a” does not, without more constraints, preclude the existence of other elements or additional elements in the system or method.

The terms like “at least one” and “one or more” may be used interchangeably throughout the description.

The terms like “verification and debugging tool”, “verification tool”, “debugging tool” and “tool” may be used interchangeably throughout the description.

The terms like “RTL code” and “code” may be used interchangeably throughout the description.

The terms like “circuit designer” and “designer” may be used interchangeably throughout the description.

The present disclosure relates to a verification and debugging tool that represents the Register Transfer Level (RTL) code objects that provides sensitive regions around and in the RTL code objects on visual display for dependency expansion and other operations. In an exemplary embodiment, to make the reader understand, the sensitive region is described as click-sensitive region. However, it may be appreciated that the sensitive region may be used for extracting information by actions such as pointing or hovering as well, thus clicking should not be construed as a limitation. The RTL code is a coding style used in digital system design and computer engineering, that is written using Hardware Description Language (HDL) like Verilog or VHDL. The RTL code defines the functioning of a digital circuit that may include multiple code blocks. In particular, RTL describes how the data transforms and flows from one register to another. The transformation of data is performed by combinational logic that exists between the registers. The operation of the RTL code is verified by using the verification tool and if any errors or problems arise in the code during its operation, the designer and/or verification engineer may use debugging tool to resolve the problems. The tool disclosed in the present disclosure provides sensitive regions around and in the code objects on the visual display for dependency expansion and other operations. The dependency expansion includes information about fan-in and fan-out for a signal, but not limited to. As explained above, the present disclosure provides the details upon actions such as clicking or pointing or hovering on the sensitive region around and in code blocks, fly lines, waveform windows etc. that allows the verification engineer to determine the details related to the code objects. Extraction and easy access of such information may avoid the need to analyze the RTL code manually, to determine the details related to the code objects. This leads to ease the process of tracking and analyzing which dramatically improves productivity.

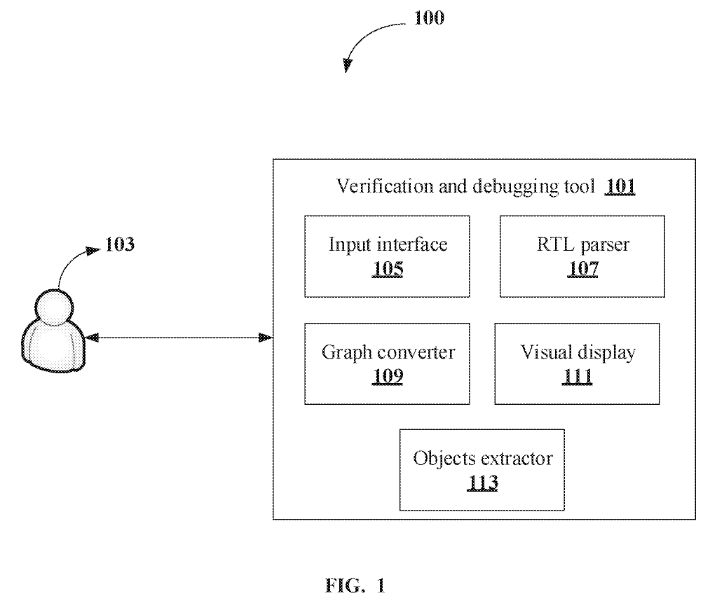

FIG. 1 shows an exemplary environment of providing sensitive regions around and in the Register Transfer Level (RTL) code objects, in accordance with some embodiments of the present disclosure.

Exemplary environment 100 includes a verification and debugging tool 101 and a user 103. The verification and debugging tool 101 may include an input interface 105, a RTL parser 107, a graph converter 109, a visual display 111 and objects extractor 113. The user 103 may interact with the verification and debugging tool 101 using the input interface 105 and the visual display 111. The input interface 105 may include, without limitation, keyboards, mouse, touchscreens, and the like, which allow direct user interaction. The input interface 105 may also receive input from any sources provided by the user 103. As an example, the input interface 105 may receive input from Uniform Resource Locator (URL). The output may be displayed on the visual display 111. As an example, the visual display 111 may include, without limitation, an electronic screen, a touchscreen and the like, which allows display of the output. In an embodiment, the verification and debugging tool 101 may be a computing device. As an example, the computing device may be any device used by the user 103 such as, but not limited to, mobile phones, smartphones, laptops, and Personal Computers (PCs). In some embodiments, the verification and debugging tool 101 may be configured within the computing device (not shown in figure).

In an embodiment, the input interface 105 may be configured to receive RTL code in a Hardware Description Language (HDL) from the user 103. The HDLs may include, without limitation, at least one of Verilog and VHSIC Hardware Description Language (VHDL). As an example, the user 103 may be a circuit designer. The RTL code may describe behavior and component connections of a circuit such as an Integrated Circuit (IC). The RTL code may include one or more code blocks describing the operations of one or more entities/components of the circuit. In an embodiment, the input interface 105 may be further configured to validate syntax of the RTL code using known techniques. If syntax error is detected, the syntax error may be displayed on the visual display 111 allowing the user 103 to edit the RTL code to rectify the syntax error.

In an embodiment, upon receiving the RTL code, the RTL parser 107 may be configured to parse the RTL code. In an embodiment, the RTL parser 107 may parse the RTL code by performing lexical and syntactic analysis to identify structural elements such as modules, signals, assignments, and control statements. Based on this analysis, the RTL parser 107 may generate an Abstract Syntax Tree (AST) that represents the hierarchical syntactic structure of the RTL code. The AST may includes nodes corresponding to language constructs and captures parent-child relationships between statements, thereby providing a structured and unambiguous representation of the RTL code for subsequent transformation into an RTL directed graph.

In an embodiment, upon generating the AST, the graph converter 109 may be configured to convert the AST into the RTL directed graph. In an embodiment, each node of the RTL directed graph may include, without limitation, at least one of a forward pointer to nodes for which the current node forms an input, and a backward pointer to nodes from which the current node receives an input. The graph converter 109 may be further configured to represent signals of the RTL code as vertices of the RTL directed graph. The graph converter 109 may also provide one or more customizable display options for the RTL directed graph. The customizable options may enable the user 103 to modify the visual representation of the RTL directed graph to suit specific debugging or analysis requirements. The one or more customizable display options may include, without limitation, color coding for different signal types or logic states, adjustable node sizes to emphasize critical modules, selectable layers for viewing control flow or data flow independently, and variable line thickness or styles to indicate signal width or type. Additional customization may include zoom functionality for detailed inspection of individual nodes, dynamic visual effects to represent changes in signal values over time, and grouping of related nodes into functional sections. These customizable display options enhance clarity, improve navigation within complex RTL designs, and facilitate efficient identification of design issues during verification and debugging. In some embodiments, the RTL directed graph may be configured to display at least one of control flow and data flow. At least one of the control flow and the data flow may be displayed in a visually distinguishable manner. The visual distinction between the control flow and the data flow may be obtained using one of different arrow styles or different colors. In other words, the visual distinction between control flow and data flow within the RTL directed graph is achieved through the use of differentiated graphical indicators. In one embodiment, the distinction is provided by employing different arrow styles, such as solid arrows for data flow and dashed arrows for control flow, or by varying arrowhead shapes to represent signal types. Alternatively, the distinction may be implemented using different colors for the respective flows, enabling clear and intuitive identification of control signals versus data paths. These visual differentiation techniques enhance the readability of complex RTL designs and facilitate efficient debugging and verification by allowing users to quickly interpret the nature of each connection within the graph.

In an embodiment, upon converting the AST into the RTL directed graph, the visual display 111 may be configured to display the plurality of code blocks, each exhibiting sensitive regions. The visual display 111 may be an infinite canvas which may be configured to display the complete RTL directed graph. The visual display 111 may also include an output interface configured to display debug information related to RTL code analysis and results (not shown in figure). In some embodiments, the visual display 111 and the output interface may be same. The visual display 111 and the output interface may also display results in a graphical format. In an embodiment, the visual display 111 may be configured to support zoom functionality for viewing details of individual code blocks or nodes. The zoom functionality may allow the user 103 to focus on specific areas of the RTL directed graph while preserving the ability to return to an overall view. The visual display 111 may also include user interface which may allow the user interactions within the visual display 111. The user interface allows the user 103 to group multiple code blocks into functional sections. The visual display 111 provides an integrated environment for real-time analysis and debugging of RTL designs. By enabling simultaneous visualization of structural elements, signal states, and dynamic behavior, the system improves design comprehension and accelerates error detection. These features collectively enhance the efficiency of verification workflows and reduce the time required for identifying and resolving design issues.

In an embodiment, upon displaying the plurality of code blocks, the objects extractor 113 may be configured to detect one or more user actions related to the sensitive regions. The sensitive regions are provided around and in each of the one or more RTL code objects to facilitate the extraction and display of relevant information regarding dependencies and operations of the RTL code upon user interactions. The objects extractor 113 may be configured to dynamically expand or annotate code objects based on the detected user action, thereby enabling visualization of interconnections, flylines, and related details. The one or more user actions may include, without limitation, clicking, pointing, or hovering on sensitive regions positioned around and within the RTL code objects displayed on the visual display 111. The sensitive regions may include, without limitation, at least one of: left, right, top, bottom, and diagonal corners of the RTL code object, each region being associated with a predefined operation including dependency expansion, fan-in and fan-out analysis, and waveform addition.

In an embodiment, the objects extractor 113 may detect clicking, pointing, or hovering on a sensitive region around an object of the RTL code. The RTL code may include one or more code blocks describing the operations of one or more entities or components of the circuit. Each code block of the RTL code may include a list of one or more signals used in the current code block to perform its corresponding operation. The one or more signals included in the code block may be referred to as nodes, and the list of these signals may be referred to as a node list. Sensitive regions may be provided around and/or within each code object displayed on the visual canvas. The RTL code object may include, without limitation, a signal, a code block, a flyline, or a waveform window. In an exemplary embodiment, the sensitive regions may be positioned on the left, right, top, and bottom of the code object. Selecting each region by clicking, pointing, or hovering may provide different details to a verification engineer checking the code. As an example, the different details may be, without limitation, generating code blocks (including wired-OR and wired-AND cases), fan-out code blocks with flylines, signal connectivity and values, waveform additions, or control/data flow distinctions. Further, upon detecting such interaction, the objects extractor 113 may invoke a specific traversal function on an underlying RTL graph, also referred to as a directed graph (DG). The RTL DG may be equivalent to the directed graph data structure in computer programming, wherein the one or more signals or nodes of the code blocks are represented as vertices of the RTL DG. In particular, the traversal function may retrieve details related to the selected code block. Subsequently, the objects extractor 113 may extract relevant objects, which may include details related to the graph. For example, the extracted details may include wired-OR cases, wired-AND cases, fan-out code blocks, and other related information depending on the action performed on the sensitive region. In some embodiments, the extraction of relevant objects may be triggered by pressing specific keyboard keys, such as Ctrl, Shift, Alt, or any combination thereof. It will be appreciated that any keyboard keys or combinations may be used to facilitate object extraction. Finally, the extracted information may be displayed on a visual display 111 associated with the computing device. In one embodiment, the information may be displayed by expanding the code blocks, while in another embodiment, the information may be displayed as flylines. It should be understood that the method of displaying the information is not limited to these examples and may include other suitable techniques as contemplated within the scope of the present disclosure.

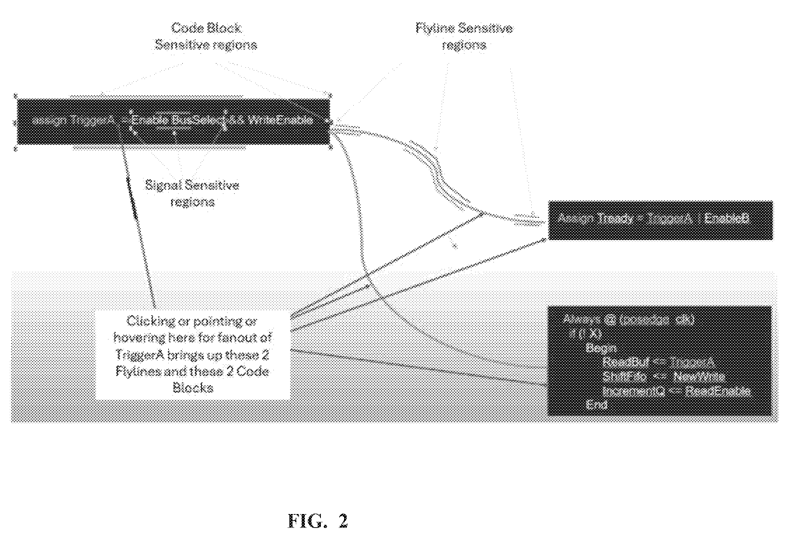

FIG. 2 shows an exemplary illustration of sensitive regions on directed graph, in accordance with an embodiment of the present disclosure. The stated representation is an exemplary embodiment and should not be construed as a limitation. A skilled person/designer may represent the code objects using different methods of displaying the information.

The RTL code may include one or more code blocks. Each Code Block (CB) of the one or more code blocks may include one or more RTL code lines. Each code line of the one or more code lines may include one or more signals upon which different operations may be performed. The objects extractor 113 114 may provide sensitive regions around a signal in a code block. As an example, without limitation, the sensitive regions may be in left, right, top and bottom of the signal. In an embodiment, the objects extractor 113 114 may provide the sensitive regions around the code blocks, flylines, waveform windows and other objects on the RTL code. Clicking or pointing or hovering on each region may provide different details to the verification engineer checking the code.

As illustrated in FIG. 2, clicking on the immediate left of the Right-Hand Side (RHS) signals may expand its generating code block or code blocks (wired OR and wired AND cases). For example, clicking on the immediate right may expand its fanout code blocks and bring them into view as connected by the flylines on the visual canvas. Referring to FIG. 2, the sensitive regions may be provided around the code block displaying code “assign TriggerA = Enable BusSelect && WriteEnable”. When a region around “Trigger A” is clicked, fanout of TriggerA brings up two flylines which display two code blocks.

In an embodiment, instead of clicking, pointing or hovering on the sensitive regions may present the information related to the code objects on the visual canvas. In an embodiment, any action performed (i.e. pointing, clicking or hovering) on the sensitive regions may carry out certain operations on the code objects. In an exemplary embodiment, clicking the click sensitive regions of a signal may select and add the signal into waveform windows. In another exemplary embodiment, hovering over a flyline may display the signals whose connectivity is being displayed along with its value.

In addition to left, right, top and bottom of the code block, additional sensitive regions may be created on the four diagonal corners of the code objects. As an example, without limitation, the additional sensitive regions may be, upper-right, upper-left, lower-right and lower-left which may be bound to specific actions. The number of actions which may be performed by the same actions may be enhanced further by using the ctrl, shift, alt and any combination of the keys. A person skilled in the art may appreciate that any keyboard keys or combination of the keys may be used to define/link specific actions. In an exemplary embodiment, the keys such as ctrl, shift, alt in combination with other keys may be used as additional qualifiers along with the above clicking actions by pressing them simultaneously. The present disclosure provides an intuitive manner for carrying out a variety of actions on the objects displayed on the visual canvas.

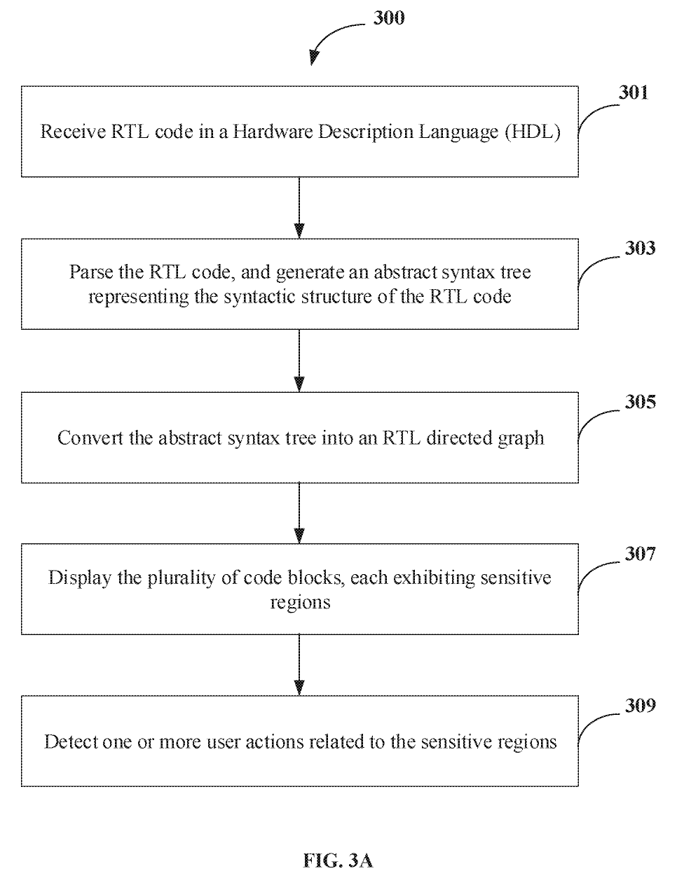

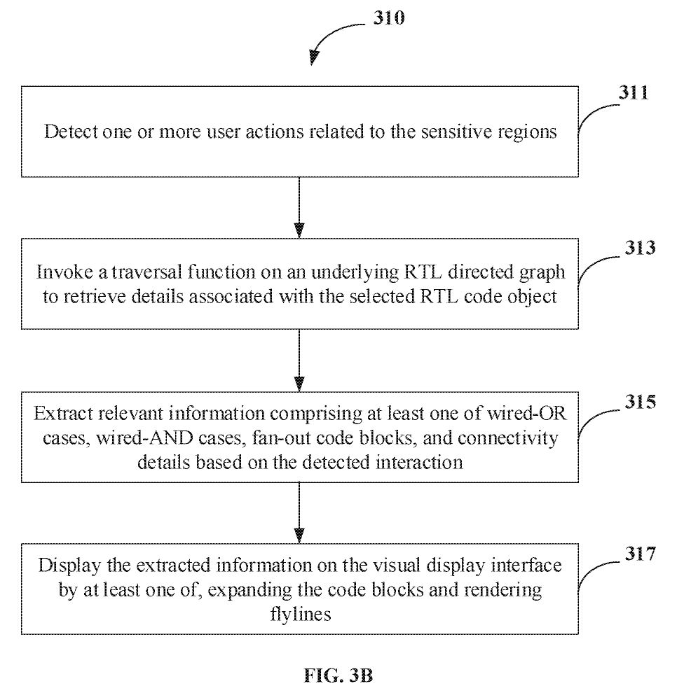

FIG. 3A shows a flowchart illustrating a method of providing sensitive regions around and in the Register Transfer Level (RTL) code objects, in accordance with some embodiments of the present disclosure.

As illustrated in FIG. 3A, the method 300 may include one or more blocks illustrating a method of providing sensitive regions around and in the Register Transfer Level (RTL) code objects, using the verification and debugging tool 101 illustrated in FIG. 1. The method 300 may be described in the general context of computer executable instructions. Generally, computer executable instructions can include routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 301, the method 300 includes receiving, by a processor of the verification and debugging tool 101, RTL code in a Hardware Description Language (HDL). The HDLs may include, at least one of Verilog and VHSIC Hardware Description Language (VHDL).

At block 303, the method 300 includes parsing, by the processor, the RTL code, and generating an abstract syntax tree representing the syntactic structure of the RTL code.

At block 305, the method 300 includes converting, by the processor, the abstract syntax tree into an RTL directed graph. The RTL directed graph comprises plurality of code blocks. Each node of the RTL directed graph may include at least one of a forward pointer to nodes for which the current node forms an input, and a backward pointer to nodes from which the current node receives an input. The processor may represent signals of the RTL code as vertices of the RTL directed graph. Further, the processor may provide one or more customizable display options for the RTL directed graph. The processor may also provide one or more customizable display options for the RTL directed graph. The one or more customizable display options may include, without limitation, at least one of color coding for different types of signals, adjustable node sizes, and selectable layers of data flow representation. Further, zoom functionality may be supported for viewing details of individual code blocks or nodes. The zoom functionality allows a user 103 to focus on specific areas of the RTL directed graph while preserving the ability to return to an overall view. The RTL directed graph may be configured to display at least one of control flow and data flow. At least one of the control flow and the data flow is displayed in a visually distinguishable manner. The visual distinction between the control flow and the data flow may be obtained using one of different arrow styles or different colors.

At block 307, the method 300 includes displaying, by the processor, the plurality of code blocks, each exhibiting sensitive regions. The processor may dynamically expand or annotates code objects based on the detected user action, thereby enabling visualization of interconnections, flylines, and related details. The one or more user actions may include, without limitation, clicking, pointing, or hovering on sensitive regions positioned around and within the RTL code objects displayed on the visual display 111. The sensitive regions may include, without limitation, at least one of: left, right, top, bottom, and diagonal corners of the RTL code object, each region being associated with a predefined operation including dependency expansion, fan-in and fan-out analysis, and waveform addition.

At block 309, the method 300 includes detecting, by the processor, one or more user actions related to the sensitive regions. The sensitive regions are provided around and in each of the one or more RTL code objects to facilitate the extraction and display of relevant information regarding dependencies and operations of the RTL code upon user interactions.

FIG. 3B shows a flow chart illustrating displaying relevant information when a sensitive region is clicked or pointed or hovered, in accordance with some embodiments of the present disclosure.

As illustrated in FIG. 3B, the method 310 may include one or more blocks illustrating a method of providing sensitive regions around and in the Register Transfer Level (RTL) code objects, using the verification and debugging tool 101 illustrated in FIG. 1. The method 310 may be described in the general context of computer executable instructions. Generally, computer executable instructions can include routines, programs, objects, components, data structures, procedures, modules, and functions, which perform specific functions or implement specific abstract data types.

The order in which the method 310 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 311, the method 310 includes detecting, by a processor of the verification and debugging tool 101, one or more user actions related to the sensitive regions. In an embodiment, the processor may detect clicking, pointing or hovering on a sensitive region around an object of RTL code. The RTL code may include the one or more code blocks describing the operations of the one or more entities/components of the circuit. A code block of the RTL code may include a list of one or more signals used in the current code block to perform its corresponding operation. The one or more signals included in the code block may be known as nodes. The list of one or more signals included in the code block may be known as a node list. As discussed earlier, the sensitive regions may be provided around and/or in each code object which is displayed on the visual canvas. The RTL code object may be a signal, a code block, a flyline, or a waveform window, but not limited thereto. As an example, without limitation, the sensitive regions may be in left, right, top and bottom of the code object. Selecting each region by clicking or pointing or hovering may provide different details to a verification engineer checking the code.

At block 313, the method 310 includes invoking, by the processor, traversal function on an underlying RTL directed graph to retrieve details associated with the selected RTL code object. In an embodiment, the processor may call specific traversal function on an underlying RTL graph (also referred as directed graph (DG)). The RTL DG may be equivalent to the directed graph data structure in computer programming. The one or more signals/nodes of the one or more code blocks may be represented as the one or more vertex of the RTL DG equivalent to vertex of the directed graph data structure in computer programming. In particular, the details related to the code block may be called.

At block 315, the method 310 includes extracting, by the processor, relevant information comprising at least one of wired-OR cases, wired-AND cases, fan-out code blocks, and connectivity details based on the detected interaction. The relevant objects may be details related to the graph. As an example, the details of the code block may provide, Wired OR and Wired AND cases, Fanout code blocks, and other related information depending on the action selected for the sensitive region. In some embodiments, the objects extractor 113 114 may extract the relevant objects when specific keys are pressed on keyboard. As an example, the specific keys may be, without limitation, ctrl, shift, alt and any combination of the keys. A person skilled in art may appreciate that any keyboard keys or combination of the keys may be used to extract the objects.

At block 317, the method 310 includes displaying, by the processor, the extracted information on the visual display 111 by at least one of, expanding the code blocks and rendering flylines. In an embodiment, the information may be displayed by expanding the code blocks. In some embodiments, the information may be displayed as the flylines. A person skilled in the art may appreciate that the method of displaying the information may not be limited to the embodiments discussed in the present disclosure. The method of displaying the information is shown in FIG. 2.

### Computer System

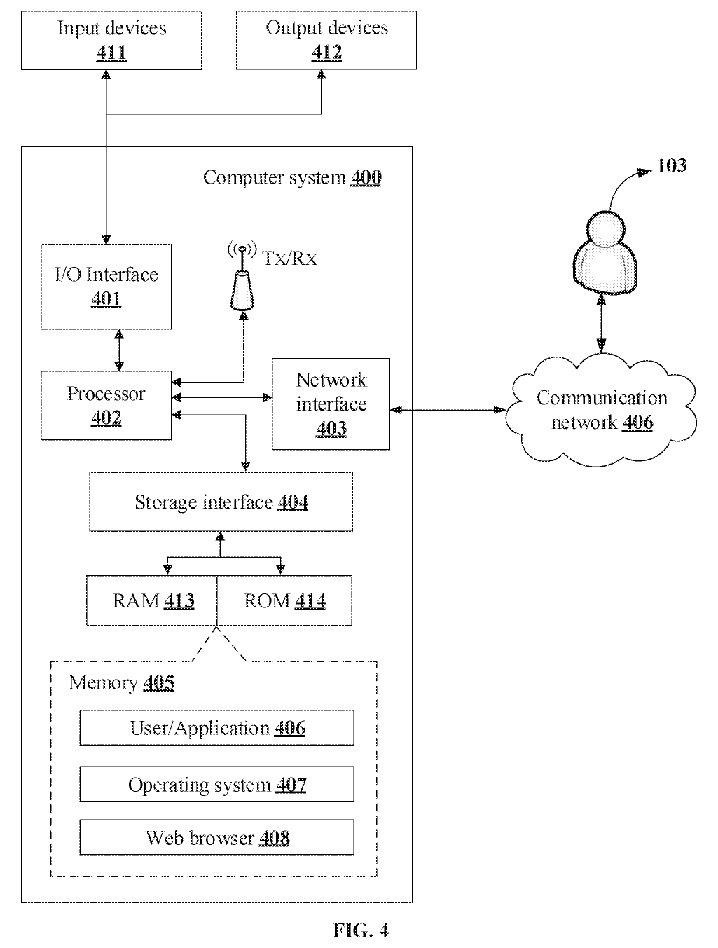

FIG. 4 illustrates a block diagram of an exemplary computer system 400 for implementing embodiments consistent with the present disclosure. In an embodiment, the computer system 400 may be a verification and debugging tool 101 illustrated in FIG. 1. The computer system 400 may include a central processing unit (“CPU” or “processor” or “memory controller”) 402. The processor 402 may comprise at least one data processor for executing program components for executing user- or system-generated business processes. A user may include a network manager, an application developer, a programmer, an organization, or any system/sub-system being operated parallelly to the computer system 400. The processor 402 may include specialized processing units such as integrated system (bus) controllers, memory controllers/memory management control units, floating point units, graphics processing units, digital signal processing units, etc.

The processor 402 may be disposed in communication with one or more Input/Output (I/O) devices (411 and 412) via I/O interface 401. The I/O interface 401 may employ communication protocols/methods such as, without limitation, audio, analog, digital, stereo, IEEE^{®}-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE^{®} 802.n /b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 401, the computer system 400 may communicate with one or more I/O devices 411 and 412.

In some embodiments, the processor 402 may be disposed in communication with a network 409 via a network interface 403. The network interface 403 may communicate with the network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE^{®} 802.11a/b/g/n/x, etc.

In an implementation, the preferred network 409 may be implemented as one of the several types of networks, such as intranet or Local Area Network (LAN) and such within the organization. The preferred network 409 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP) etc., to communicate with each other. Further, the network 409 may include a variety of network devices, including routers, bridges, RAN nodes, computing devices, storage devices, etc. Using the network interface 403 and the network 409, the computer system 400 may communicate with a user 103.

In some embodiments, the processor 402 may be disposed in communication with a memory 405 (e.g., RAM 413, ROM 414, etc. as shown in FIG. 6) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application interface 406, an operating system 407, a web browser 408, and the like. In some embodiments, computer system 400 may store user/application data 406, such as the data, variables, records, etc. as described in this invention. Such databases may be implemented as fault-tolerant, relational, scalable, secure databases such as Oracle^{®} or Sybase^{®}.

The operating system 407 may facilitate resource management and operation of the computer system 400. Examples of operating systems include, without limitation, APPLE^{®} MACINTOSH^{®} OS X^{®}, UNIX^{®}, UNIX-like system distributions (E.G., BERKELEY SOFTWARE DISTRIBUTION^{®} (BSD), FREEBSD^{®}, NETBSD^{®}, OPENBSD, etc.), LINUX^{®} DISTRIBUTIONS (E.G., RED HAT^{®}, UBUNTU^{®}, KUBUNTU^{®}, etc.), IBM^{®} OS/2^{®}, MICROSOFT^{®} WINDOWS^{®} (XP^{®}, VISTA^{®}/7/8, 10 etc.), APPLE^{®} IOS^{®}, GOOGLE ^{TM} ANDROID ^{TM}, BLACKBERRY^{®} OS, or the like.

The user interface 406 may facilitate display, execution, interaction, manipulation, or operation of program components through textual or graphical facilities. For example, the user interface 406 may provide computer interaction interface elements on a display system operatively connected to the computer system 400, such as cursors, icons, check boxes, menus, scrollers, windows, widgets, and the like. Further, Graphical User Interfaces (GUIs) may be employed, including, without limitation, APPLE^{®} MACINTOSH^{®} operating systems’ Aqua^{®}, IBM^{®} OS/2^{®}, MICROSOFT^{®} WINDOWS^{®} (e.g., Aero, Metro, etc.), web interface libraries (e.g., ActiveX^{®}, JAVA^{®}, JAVASCRIPT^{®}, AJAX, HTML, ADOBE^{®} FLASH^{®}, etc.), or the like.

The web browser 408 may be a hypertext viewing application. Secure web browsing may be provided using Secure Hypertext Transport Protocol (HTTPS), Secure Sockets Layer (SSL), Transport Layer Security (TLS), and the like. The web browsers 408 may utilize facilities such as AJAX, DHTML, ADOBE^{®} FLASH^{®}, JAVASCRIPT^{®}, JAVA^{®}, Application Programming Interfaces (APIs), and the like. Further, the computer system 400 may implement a mail RAN node stored program component. The mail RAN node may utilize facilities such as ASP, ACTIVEX^{®}, ANSI^{®} C++/C#, MICROSOFT^{®}, .NET, CGI SCRIPTS, JAVA^{®}, JAVASCRIPT^{®}, PERL^{®}, PHP, PYTHON^{®}, WEBOBJECTS^{®}, etc. The mail RAN node may utilize communication protocols such as Internet Message Access Protocol (IMAP), Messaging Application Programming Interface (MAPI), MICROSOFT^{®} exchange, Post Office Protocol (POP), Simple Mail Transfer Protocol (SMTP), or the like. In some embodiments, the computer system 400 may implement a mail client stored program component. The mail client may be a mail viewing application, such as APPLE^{®} MAIL, MICROSOFT^{®} ENTOURAGE^{®}, MICROSOFT^{®} OUTLOOK^{®}, MOZILLA^{®} THUNDERBIRD^{®}, and the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

In light of the technical advancements provided by the disclosed method, the claimed steps, as discussed above, are not routine, conventional, or not well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The terms "an embodiment", "embodiment", "embodiments", "the embodiment", "the embodiments", "one or more embodiments", "some embodiments", and "one embodiment" mean "one or more (but not all) embodiments of the invention(s)" unless expressly specified otherwise.

The terms "including", "comprising", “having” and variations thereof mean "including but not limited to", unless expressly specified otherwise.

The enumerated listing of items does not imply that any or all the items are mutually exclusive, unless expressly specified otherwise. The terms "a", "an" and "the" mean "one or more", unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A verification and debugging tool for Register Transfer Level (RTL) code, the verification and debugging tool comprising:
an input interface configured to receive RTL code in a Hardware Description Language (HDL);
an RTL parser configured to:
parse the RTL code, and
generate an abstract syntax tree of the RTL code;
a graph converter configured to convert the abstract syntax tree into an RTL directed graph,
wherein the RTL directed graph comprises plurality of code blocks, and
wherein each of the plurality of code blocks is represented as a node;
a visual display configured to display the plurality of code blocks, each exhibiting sensitive regions; and
an objects extractor configured to detect one or more user actions related to the sensitive regions, wherein the sensitive regions are provided around and in each of the one or more RTL code objects to facilitate the extraction and display of relevant information regarding dependencies and operations of the RTL code upon user interactions.

2. The verification and debugging tool of claim 1, wherein the objects extractor is further configured to:
detect one or more user actions related to the sensitive regions;
invoke a traversal function on an underlying RTL directed graph to retrieve details associated with the selected RTL code object;
extract relevant information comprising at least one of wired-OR cases, wired-AND cases, fan-out code blocks, and connectivity details based on the detected interaction; and
display the extracted information on the visual display by at least one of, expanding the code blocks and rendering flylines.

3. The method as claimed in claim 1, wherein the visual display dynamically expands or annotates code objects based on the detected user action, thereby enabling visualization of interconnections, flylines, and related details.

4. The verification and debugging tool of claim 1, wherein the one or more user actions comprises clicking, pointing, or hovering on sensitive regions positioned around and within the RTL code objects displayed on the visual display.

5. The verification and debugging tool of claim 1, wherein the sensitive regions comprises at least one of: left, right, top, bottom, and diagonal corners of the RTL code object, each region being associated with a predefined operation including dependency expansion, fan-in and fan-out analysis, and waveform addition.

6. The verification and debugging tool of claim 1, wherein the sensitive regions provided around the RTL code objects facilitate the extraction of relevant information including at least: details regarding signal connections within the RTL code objects; and
functionality attributes of the RTL code objects.

7. The verification and debugging tool of claim 1, wherein each node of the RTL directed graph comprises at least one of a forward pointer to nodes for which the current node forms an input, and a backward pointer to nodes from which the current node receives an input.

8. The verification and debugging tool of claim 1, wherein the graph converter is further configured to represent signals of the RTL code as vertices of the RTL directed graph.

9. The verification and debugging tool of claim 1, further comprising:
an output interface configured to display debug information related to RTL code analysis and results, wherein the output interface is configurable to show results in a graphical format.

10. The verification and debugging tool of claim 1, wherein the one or more HDLs comprises at least one of Verilog and VHSIC Hardware Description Language (VHDL).

11. The verification and debugging tool of claim 1, wherein the graph converter is further configured to provide one or more customizable display options for the RTL directed graph.

12. The verification and debugging tool of claim 11, wherein the one or more customizable display options comprises at least one of color coding for different types of signals, adjustable node sizes, and selectable layers of data flow representation.

13. The verification and debugging tool of claim 1, wherein the visual display is configured to support zoom functionality for viewing details of individual code blocks or nodes.

14. The verification and debugging tool of claim 13, wherein the zoom functionality allows a user to focus on specific areas of the RTL directed graph while preserving the ability to return to an overall view.

15. The verification and debugging tool of claim 1, further comprises:
a user interface designed to allow user interactions within the visual display, wherein the user interface allows the user to group multiple code blocks into functional sections.

16. The verification and debugging tool of claim 1, wherein the RTL directed graph is configured to display at least one of control flow and data flow, wherein the at least one of the control flow and the data flow is displayed in a visually distinguishable manner.

17. The verification and debugging tool of claim 16, wherein the visual distinction between the control flow and the data flow is obtained using one of different arrow styles or different colors.

18. A method of providing sensitive regions around and in the Register Transfer Level (RTL) code objects on visual display, the method comprising:
receiving RTL code in a Hardware Description Language (HDL);
parsing the RTL code, and generating an abstract syntax tree representing the syntactic structure of the RTL code;
converting the abstract syntax tree into an RTL directed graph,
wherein the RTL directed graph comprises plurality of code blocks, and
wherein each of the plurality of code blocks is represented as a node;
displaying the plurality of code blocks, each exhibiting sensitive regions; and
detecting one or more user actions related to the sensitive regions, wherein the sensitive regions are provided around and in each of the one or more RTL code objects to facilitate the extraction and display of relevant information regarding dependencies and operations of the RTL code upon user interactions.

19. A non-transitory computer readable medium including instructions stored thereon that when processed by at least one processor, cause a verification and debugging tool to perform operations comprising:
receiving RTL code in a Hardware Description Language (HDL);
parsing the RTL code, and generating an abstract syntax tree representing the syntactic structure of the RTL code;
converting the abstract syntax tree into an RTL directed graph,
wherein the RTL directed graph comprises plurality of code blocks, and
wherein each of the plurality of code blocks is represented as a node;
displaying the plurality of code blocks, each exhibiting sensitive regions; and
detecting one or more user actions related to the sensitive regions, wherein the sensitive regions are provided around and in each of the one or more RTL code objects to facilitate the extraction and display of relevant information regarding dependencies and operations of the RTL code upon user interactions.
